(19) United States
(12) Patent Application Publication
(10) Pub. No.: US 2021/0395433 A1
(43) Pub. Date: Dec. 23, 2021

(54) Polyisocyanurate Foams with Flame Retardant Properties and Process for Making the Same

(71) Applicant: SES Foam, LLC, Spring, TX (US)

(72) Inventors: Jose Luna, Pasadena, TX (US); Charles Valentine, Spring, TX (US)

(73) Assignee: SES Foam, LLC, Spring, TX (US)

(21) Appl. No.: 17/354,107

(22) Filed: Jun. 22, 2021

Related U.S. Application Data
(60) Provisional application No. 63/042,161, filed on Jun. 22, 2020.

(51) Int. Cl. C08G 18/42; C08G 18/73; C08J 9/14; C08L 75/06

(52) U.S. Cl. CPC C08G 18/4208; C08G 18/73; C08G 2101/00; C08L 75/06; C08J 9/144

(57) ABSTRACT

This disclosure provides for new polyisocyanurate (PIR) foams that exhibit improved flame retardant properties and thermal barrier properties, and which can pass certain thermal barrier tests in the absence of a protective covering such as specified in the thermal barriers codes. In an aspect, it has been unexpectedly discovered that when a relatively high viscosity and high functionality polyisocyanate is used with a high aromatic content polyester polyol and an HFO and/or HCFO blowing agent, and a flame retardant compound, unexpectedly good flame retardant polyisocyanurate foams can be generated, for example, when a high A-side:B-side volume ratio (v:v) and a relatively high Isocyanate Index (ISO Index) are used in the process.

### RELATED APPLICATION(S)

This application claims priority to and the benefit of U.S. Provisional Application No. 63/042,161, filed Jun. 22, 2020, which is incorporated herein by reference in its entirety.

### TECHNICAL FIELD OF THE DISCLOSURE

This disclosure relates to polyisocyanurate foams, including foams with flame retardant properties, and compositions and processes for making these foams.

### BACKGROUND OF THE DISCLOSURE

Polyurethane (PUR) and polyisocyanurate (PIR) foams are used extensively in a wide array of commercial and industrial applications. The formation of polyurethane and polyisocyanurate foams can be effected by combining or contacting a polyol composition such as a polyol resin composition with an polyisocyanate composition in the presence of a blowing agent. The ensuing polymerization of the components upon contact forms a polyurethane or polyisocyanurate, and in the presence of a blowing agent, generates a PUR or PIR foam.

A major end use of these polymeric foams is for residential and commercial building insulation. However, polyurethane foam is combustible and is required to be protected from occupied (habitable) space in the International Building Code, International Residential Code, National Fire Protection Association Codes, and other building codes. Protection of the foam is generally provided by covering the foam with a code-prescribed thermal barrier, such as ½″ gypsum wall board. Other thermal barriers or coverings can be approved by passing end use configuration testing codes and standards such as NFPA 286, UL 1715, and others.

What would be helpful in polyurethane foam technologies are foams that are readily and conveniently prepared that exhibit improved fire and flame retardant and thermal barrier properties. For example, a polyurethane foam that is capable of passing certain thermal barrier tests in the absence of a protective covering such as code-prescribed thermal barriers would be very useful.

### SUMMARY OF THE DISCLOSURE

This disclosure provides for new polyisocyanurate (PIR) foams that exhibit improved fire and flame retardant properties and thermal barrier properties, and which are easy and convenient to prepare using existing equipment. The foams prepared according to this disclosure may be capable of passing certain thermal barrier tests in the absence of a protective covering such as specified in the thermal barriers codes discussed herein. Improved processes for manufacturing the foams are also provided, which combine certain compositions and conditions in a non-obvious manner.

In an aspect, for example, certain combinations of the following precursor properties or process parameters used to fabricate the polyisocyanurate foam may be useful for providing the improved properties: (a) a relatively high viscosity and high functionality polyisocyanate component in the A-side composition; (b) a polyester polyol having a relatively high aromatic content; (c) at least one of a hydrofluoroolefin (HFO) or a hydrochlorofluoroolefin (HCFO) blowing agent; (d) an “off-ratio” A-side:B-side volume ratio (v:v) which includes a higher volume of A-side than the volume of B-side and therefore which departs from the roughly 1:1 (v:v) ratio common in conventional polyurethanes; and (e) an Isocyanate Index (ISO Index) that is from about 150 to about 375 (expressed as a percentage).

Therefore, in an aspect, this disclosure provides a flame-retardant polyisocyanurate (PIR) foam, the foam comprising the contact product of:
(a) a first reaction composition (A-side) comprising a polyisocyanate component having a viscosity (25° C., mPa·S) of from about 600 cP to about 850 cP and having [1] an isocyanate functionality of from about 2.5 to about 3.5, or [2] an NCO content (wt %) of from about 25 wt % to about 35 wt %; and
(b) a second reaction composition (B-side) comprising:
   an aromatic polyester polyol comprising a phthalate-based aromatic content of at least about 30 wt %;
   a blowing agent comprising a hydrofluoroolefin (HFO), a hydrochlorofluoroolefin (HCFO), or a combination thereof;
   a polyurethane producing catalyst;
   a flame retardant; and
   a surfactant;
wherein the first reaction composition (A-side) and the second reaction composition (B-side) are used in amounts to provide an A-side:B-side volume ratio (v:v) of from 1.2:1 to 2.2:1; and
wherein the first reaction composition and the second reaction composition are used in amounts to provide an Isocyanate Index of 150 to 375 (expressed as a percentage).

Accordingly, there is also provided a process for making a flame-retardant polyisocyanurate (PIR) foam, the process comprising contacting: (a) the first reaction composition (A-side) comprising a polyisocyanate component having a viscosity (25° C., mPa·S) of from about 600 cP to about 850 cP and having [1] an isocyanate functionality of from about 2.5 to about 3.5, or [2] an NCO content (wt %) of from about 25 wt % to about 35 wt %; and (b) a second reaction composition (B-side) comprising: an aromatic polyester polyol comprising a phthalate-based (or terephthalate-based) aromatic content of at least about 30 wt %; a blowing agent comprising a hydrofluoroolefin (HFO), a hydrochlorofluoroolefin (HCFO), or a combination thereof; a polyurethane producing catalyst; a flame-retardant; and a surfactant; wherein the first reaction composition (A-side) and the second reaction composition (B-side) are used in amounts to provide an A-side:B-side volume ratio (v:v) of from 1.2:1 to 2.2:1; and wherein the first reaction composition and the second reaction composition are used in amounts to provide an Isocyanate Index of 150 to 375.

These and other embodiments and aspects of the processes, methods, and compositions are described more fully in the Detailed Description and claims and further disclosure such as the Examples provided herein.

### BRIEF DESCRIPTION OF THE FIGURES

FIG. 1 illustrates the three methods for calculating the aromatic content of the aromatic polyester polyol used according to this disclosure, namely, Method A which is a phenyl-based aromatic content calculation (wt % C₆H₄), Method B which is a phthaloyl-based (or terephthaloyl-based) aromatic content calculation (wt % C₈H₄O₂), and Method C which is a phthalate-based (or terephthalate-based) aromatic content calculation (wt % C₈H₄O₄).

### DETAILED DESCRIPTION OF THE DISCLOSURE

### Definitions

To define more clearly the terms used herein, the following definitions are provided, and unless otherwise indicated or the context requires otherwise, these definitions are applicable throughout this disclosure. If a term is used in this disclosure but is not specifically defined herein, the definition from the IUPAC Compendium of Chemical Terminology, 2^{nd} Ed (1997) can be applied, as long as that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein controls.

Regarding claim transitional terms or phrases, the transitional term “comprising”, which is synonymous with “including,” “containing,” or “characterized by,” is inclusive or open-ended and does not exclude additional, unrecited elements or method steps. The transitional phrase “consisting of” excludes any element, step, or ingredient not specified in the claim. The transitional phrase “consisting essentially of” limits the scope of a claim to the specified materials or steps and those that do not materially affect the basic and novel characteristic(s) of the claimed invention. Unless specified to the contrary, describing a compound or composition “consisting essentially of” is not to be construed as “comprising,” but is intended to describe the recited component that includes materials which do not significantly alter composition or method to which the term is applied. For example, a feedstock consisting essentially of a material A can include impurities typically present in a commercially produced or commercially available sample of the recited compound or composition. When a claim includes different features and/or feature classes (for example, a method step, feedstock features, and/or product features, among other possibilities), the transitional terms comprising, consisting essentially of, and consisting of, apply only to feature class to which is utilized and it is possible to have different transitional terms or phrases utilized with different features within a claim. For example a method can comprise several recited steps (and other non-recited steps) but utilize a catalyst composition preparation consisting of specific steps but utilize a catalyst composition comprising recited components and other non-recited components. While compositions and methods are described in terms of “comprising” various components or steps, the compositions and methods can also “consist essentially of” or “consist of” the various components or steps.

The terms “a,” “an,” and “the” are intended, unless specifically indicated otherwise, to include plural alternatives, e.g., at least one. For instance, the disclosure of “a polyol” is meant to encompass one polyol compound, or mixtures or combinations of more than one polyol compound unless otherwise specified.

The terms “configured for use” or “adapted for use” and similar language is used herein to reflect that the particular recited structure or procedure is used in a polyisocyanurate spray foam system or process, including for use with high pressure proportioners used in polyisocyanurate spray foam systems. For example, unless otherwise specified, a particular structure “configured for use” means it is “configured for use in a polyisocyanate spray foam system” and therefore is designed, shaped, arranged, constructed, and/or tailored to effect a combination of an A-side composition and a B-side composition resulting in a polymerization, as would have been understood by the skilled person.

In an aspect, the materials and processes are drawn to a polyisocyanurate (PIR) foam, although in this disclosure, the terms polyurethane (PUR) and polyisocyanurate (PIR) may be used interchangeably and without prejudice. For example, the precursors for forming these foams are similar In an aspect, for example, preparing a PIR foam may involve, using a polyisocyanate (A-side) that has a higher proportion of methylene diphenyl diisocyanate (MDI) than used in forming a PUR, along with a polyester polyol (B-side) rather than a polyether polyol as commonly used in a PUR. In still another aspect, for example, preparing a PIR foam may involve using a polyether polyol (B-side) as the crosslinker as is commonly used in a PUR.

The terms “flame retardant chemical”, “fire retardant chemical”, or simply “flame retardant” or “fire retardant” when used herein to refer to the additive or treatment that is used to treat or condition a material such as a PIR foam refers to an element, a chemical compound, agent or composition which has the ability to reduce or eliminate the tendency of a substance or a substrate to which it is added to burn when the substance or substrate is exposed to a flame or fire. The flame retardant chemicals selected are suitable for combination with or use with the one or more substances or substrates which they treat or to which they are added, which may be determined by those of skill in the art.

Terms such as “flame retardant”, “fire retardant”, “flame resistant,” “fire resistant,” and the like may also be used to refer to a substance to which a flame retardant chemical has been added or a substrate which has been treated or coated with a flame retardant chemical. For example, this disclosure provides for a flame retardant polyisocyanurate (PIR) foam, one component of which is a flame retardant chemical. In one aspect, these terms may be used herein to refer to substances or materials which: (a) do not support a flame, fire and/or combustion, either while a flame or fire is present, or once a source of heat or ignition is removed; and/or (b) are retardant to, or incapable of, burning (being essentially fireproof, that is undergoing virtually no change when exposed to flame, fire and/or combustion process). A flame resistant substance, material, or substrate may char and/or melt.

The term “open cell” or “open cell foam”, as used herein, refers to a foam having at least 20 percent open cells as measured in accordance with ASTM D 2856-A.

The term “functionality” when used to describe a polyisocyanate and similar terms such as “MDI functionality”, “polyisocyanate functionality”, or “isocyanate functionality”, refer to the number average isocyanate functionality of all isocyanates used in the polyisocyanate component for preparing a polyurethane or polyisocyanurate foam. Isocyanate functionality may be abbreviated Fn.

As used herein, “MDI” refers to methylene diphenyl diisocyanate, also called diphenylmethane diisocyanate, and the isomers thereof. MDI exists as one of three isomers (4,4′ MDI, 2,4′ MDI, and 2,2′ MDI), or as a mixture of two or more of these isomers. As used herein, unless specifically stated otherwise, “MDI” may also refer to, and encompass, polymeric MDI (sometimes termed “PMDI”). Polymeric MDI is a compound that has a chain of three or more benzene rings connected to each other by methylene bridges, with an isocyanate group attached to each benzene ring. For example, one conventional MDI may have an average functionality from about 2.1 to about 3, inclusive, with a typical viscosity of about 200 mPa at 25° C.

The terms “Isocyanate Index”, “NCO index”, “ISO Index” and the like are used as understood by the person of ordinary skill to refer to the ratio of the number of NCO groups (which refers to the —N═C═O functional group) or equivalents (from the A-side) to the number of isocyanate-reactive hydrogen atoms or equivalents (from the B-side) that are used in a formulation. The Isocyanate Index can be reported as either a fraction or a percentage, therefore, the Isocyanate Index reported as a percentage is calculated as follows:

$$\frac{[ N C O ] \times 100}{[ active hydrogens ]} .$$

In other words, the NCO index expresses the amount of isocyanate actually used in a formulation with respect to the amount of isocyanate theoretically required for a stoichiometric reaction with the amount of isocyanate-reactive hydrogens used in the formulation. An Isocyanate Index of 100 (percent) reflects a 1:1 ratio (molar or number) of NCO groups to active hydrogens. In the Examples, the NCO index is reported both as a fraction and a percentage.

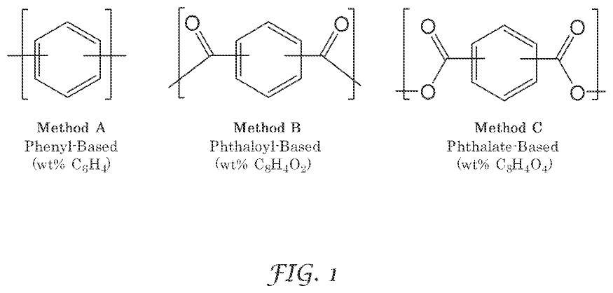

In the polyurethane, polyisocyanurate, and polyester polyol industries, various manufacturers and practitioners calculate the “aromatic content” of an aromatic polyester polyol in different ways. For example, some practitioners such as some polyurethane and polyisocyanurate manufacturers may calculate “aromatic content” as the weight percent (wt %) of the total phenyl ring moieties in the polyester polyol, without including carbonyl or carboxyl moieties bonded to the phenyl rings in the calculation, which may be referred to herein as “phenyl-based” aromatic content, and calculated as the wt % C₆H₄, which also may be referred to as Method A. Other manufacturers and practitioners such as some polyester polyol manufacturers may calculate “aromatic content” as the weight percent (wt %) of the total phenyl ring moieties plus the CO (“carbonyl”) groups bonded to the phenyl rings in the polyester polyol, which may be referred to herein as “phthaloyl-based” aromatic content or “terephthaloyl-based” aromatic content, and calculated as the wt % C₈H₄O₂, which also may be referred to as Method B. In this disclosure “phthaloyl-based” and “terephthaloyl-based” are used interchangeably, regardless of the regiochemistry of the CO groups. Still other manufacturers and practitioners may calculate “aromatic content” as the weight percent (wt %) of the total phenyl ring moieties plus the CO₂ (carboxy or carboxyl) groups bonded to the phenyl rings in the polyester polyol, which may be referred to herein as “phthalate-based” aromatic content or “terephthalate-based” aromatic content, and calculated as the wt % C₈H₄O₂, which also may be referred to as Method C. In this disclosure “phthalate-based” and “terephthalate-based” are used interchangeably, regardless of the regiochemistry of the CO₂ groups. These three methods of calculating aromatic content are illustrated in FIG. 1. Obviously, the phenyl-based aromatic content calculation (wt % C₆H₄), the phthaloyl-based aromatic content calculation (wt % C₈H₄O₂), and the phthalate-based aromatic content calculation (wt % C₈H₄O₄) provide very different values for “aromatic content” for an aromatic polyester polyol. In this disclosure, a distinction in any recited aromatic content values is made according to how the aromatic content calculation is made. For example, the aromatic polyester polyol can be Isoexter® TL 250, which is reported to have an aromatic content of 21% (phenyl-based) or 38% (terephthalate based).

The terms “optional” or “optionally” are used to mean that the subsequently described component, event, or circumstance may or may not be used or occur, and that the description includes instances where the component, event, or circumstance occurs and instances where it does not. For example, the phrase “optionally substituted” means that the compound referenced may or may not be substituted and that the description includes both unsubstituted compounds and compounds where there is substitution.

Various numerical ranges are disclosed herein. When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. For example, by disclosing a temperature of from 70° C. to 80° C., Applicant's intent is to recite individually 70° C., 71° C., 72° C., 73° C., 74° C., 75° C., 76° C., 77° C., 78° C., 79° C., and 80° C., including any sub-ranges and combinations of sub-ranges encompassed therein, and these methods of describing such ranges are interchangeable. Moreover, all numerical end points of ranges disclosed herein are approximate, unless excluded by proviso. As a representative example, if Applicant states that one or more steps in the processes disclosed herein can be conducted at a temperature in a range from 10° C. to 75° C., this range should be interpreted as encompassing temperatures in a range from “about” 10° C. to “about” 75° C.

Values or ranges may be expressed herein as “about”, from “about” one particular value, and/or to “about” another particular value. When such values or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed therein, and that each value is also herein disclosed as “about” that particular value in addition to the value itself. In another aspect, use of the term “about” means ±15% of the stated value, ±10% of the stated value, ±5% of the stated value, or ±3% of the stated value.

Applicant reserves the right to proviso out or exclude any individual members of any such group of values or ranges, including any sub-ranges or combinations of sub-ranges within the group, that can be claimed according to a range or in any similar manner, if for any reason Applicant chooses to claim less than the full measure of the disclosure, for example, to account for a reference that Applicant may be unaware of at the time of the filing of the application. Further, Applicant reserves the right to proviso out or exclude any individual substituents, analogs, compounds, ligands, structures, or groups thereof, or any members of a claimed group, if for any reason Applicant chooses to claim less than the full measure of the disclosure, for example, to account for a reference or prior disclosure that Applicant may be unaware of at the time of the filing of the application.

All publications and patents mentioned herein are incorporated herein by reference for the purpose of describing and disclosing, for example, the constructs and methodologies that are described in the publications, which might be used in connection with the presently described invention. The publications discussed throughout the text are provided solely for their disclosure prior to the filing date of the present application. Nothing herein is to be construed as an admission that the inventors are not entitled to antedate such disclosure by virtue of prior invention.

### Description

This disclosure provides for new polyisocyanurate (PIR) foams that exhibit improved fire and flame retardant properties and thermal barrier properties, and which can pass certain thermal barrier tests in the absence of a protective covering such as specified in the thermal barriers codes. In an aspect, it has been unexpectedly discovered that when a relatively high viscosity and high functionality polyisocyanate is used with a high aromatic content polyester polyol and an HFO and/or HCFO blowing agent, and a flame retardant compound, unexpectedly good flame retardant polyisocyanurate foams can be generated. These components provide the good flame retardant polyisocyanurate foams particularly when a high A-side:B-side volume ratio (v:v) and a relatively high Isocyanate Index (ISO Index) are used in the process.

In an aspect, this disclosure provides a flame-retardant polyisocyanurate (PIR) foam, the foam comprising the contact product of:
(a) a first reaction composition (A-side) comprising a polyisocyanate component having a viscosity (25° C., mPa·S) of from about 600 cP to about 850 cP and having [1] an isocyanate functionality of from about 2.5 to about 3.5, or [2] an NCO content (wt %) of from about 25 wt % to about 35 wt %; and
(b) a second reaction composition (B-side) comprising:
   an aromatic polyester polyol comprising a phthalate-based aromatic content of at least about 30 wt %;
   a blowing agent comprising a hydrofluoroolefin (HFO), a hydrochlorofluoroolefin (HCFO), or a combination thereof;
   a polyurethane producing catalyst;
   a flame retardant; and
   a surfactant;
wherein the first reaction composition (A-side) and the second reaction composition (B-side) are used in amounts to provide an A-side:B-side volume ratio (v:v) of from 1.2:1 to 2.2:1; and
wherein the first reaction composition and the second reaction composition are used in amounts to provide an Isocyanate Index of 150 to 375 (expressed as a percentage).

In a further aspect, this disclosure provides a process for making a flame-retardant polyisocyanurate (PIR) foam, the process comprising contacting:
(a) a first reaction composition (A-side) comprising a polyisocyanate component having a viscosity (25° C., mPa·S) of from about 600 cP to about 850 cP and having [1] an isocyanate functionality of from about 2.5 to about 3.5, or [2] an NCO content (wt %) of from about 25 wt % to about 35 wt %; and
(b) a second reaction composition (B-side) comprising:
   an aromatic polyester polyol comprising a phthalate-based aromatic content of at least about 30 wt %;
   a blowing agent comprising a hydrofluoroolefin (HFO), a hydrochlorofluoroolefin (HCFO), or a combination thereof;
   a polyurethane producing catalyst;
   a flame-retardant; and
   a surfactant;
wherein the first reaction composition (A-side) and the second reaction composition (B-side) are used in amounts to provide an A-side:B-side volume ratio (v:v) of from 1.2:1 to 2.2:1; and

wherein the first reaction composition and the second reaction composition are used in amounts to provide an Isocyanate Index of 150 to 375.

According to an aspect, the components used to make the foams of this disclosure may be used with high pressure systems, and the resulting foams may be referred to as high pressure foams. For example, spray foam systems which can be used in producing the disclosed foams include those with proportioners operating from about 800 psi to about 2500 psi, from about 1000 psi to about 2400 psi, from about 1100 psi to about 2250 psi, from about 1200 psi to about 2000 psi, and any subranges within these ranges, to pressurize the reaction compositions. These pressures contrast with the industry norm systems and components which generally operate at lower upper pressures such as up to about 1000 psi or even 1500 psi and further contrast with the more consumer-oriented systems and components which generally operate at low pressures, for example of from about 200 psi to about 300 psi.

These and other aspects of the present disclosure are explained in additional detail herein, as follows.

Polyisocyanate Component. As described above, the first reaction composition which is referred to as the A-side can comprise a polyisocyanate component having a viscosity (25° C., mPa·S) of from about 600 cP to about 850 cP. In addition, the polyisocyanate can have either [1] an isocyanate functionality of from about 2.5 to about 3.5, or [2] an NCO content (wt %) of from about 25 wt % to about 35 wt %, or a combination of this isocyanate functionality and NCO content (wt %).

In one aspect, the polyisocyanate component as used herein can have a viscosity (25° C., mPa·S) of from about 600 cP to about 850 cP. The polyisocyanate component may also have a viscosity (25° C., mPa·S) of from about 650 cP to about 750 cP; alternatively, from about 670 cP to about 730 cP; or alternatively, from about 685 cP to about 715 cP. Alternatively, the polyisocyanate component may also have a viscosity (25° C., mPa·S) of about 600 cP, about 625 cP, about 650 cP, about 675 cP, about 700 cP, about 725 cP, about 750 cP, about 775 cP, about 800 cP, about 825 cP, or about 850 cP, or any ranges or collection of ranges therebetween. It will be appreciated by the skilled artisan that the SI units for dynamic viscosity of mPa·S are equivalent to the cgs units of centipoise, as 1 cP=10⁻³ Pa·S=1 mPa·S.

According to another aspect, the first reaction composition (A-side) can comprise a polyisocyanate component having a relatively low viscosity (25° C., mPa·S) of from about 100 cP to about 300 cP, for example, WANNATE® PM-700 from Wanhau USA. In this aspect, the other components and process parameters can be the same or substantially the same as those disclosed herein when using the higher viscosity polyisocyanate component.

In a further aspect, the polyisocyanate component as used herein can have an isocyanate functionality of from about 2.5 to about 3.5; alternatively, from about 2.7 to about 3.3; alternatively, from about 2.8 to about 3.3; or alternatively, from about 2.8 to about 3.2. Further still, the polyisocyanate component as used herein can have an isocyanate functionality of about 2.5, about 2.6, about 2.7, about 2.8, about 2.9, about 3.0, about 3.1, about 3.2, about 3.3, about 3.4, about 3.5, or any ranges or collection of ranges therebetween.

In yet another aspect, the polyisocyanate component as used herein can have an NCO content (wt %) of from 25 wt % to about 35 wt %, or about 27 wt % to about 33 wt %. Alternatively, the polyisocyanate component used herein can have an NCO content (wt %) of about 25 wt %, about 26 wt %, about 27 wt %, about 28 wt %, about 29 wt %, about 30 wt %, about 31 wt %, about 32 wt %, about 33 wt %, about 34 wt %, about 35 wt %, or any ranges or collection of ranges therebetween.

An example of a polyisocyanate component that is useful in the foams and processes disclosed herein is WANNATE® PM-700 from Wanhau USA, which can comprise from about 30 wt % to about 70 wt % of polymeric methylene diphenyl diisocyanate (polymeric MDI or “PMDI”) and from about 70 wt % to about 30 wt % methylene diphenyl diisocyanate MDI according to the product specification information. This PM-700 can have a viscosity (25° C., mPa·S) of from about 600 cP to about 850 cP, for example, about 700 cP. The NCO content of this PM-700 can be from about 30.0 to about 32.0, and its density is between about 1.22 gm/cm³ to about 1.25 gm/cm³.

In some embodiments, the polyisocyanate component used in the contact product to make the polyisocyanurate foam can have an isocyanate functionality of from about 3.0 to about 3.1, an NCO content (wt %) of from about 29 wt % to about 33 wt %, and a viscosity (25° C., mPa·S) of from about 650 cP to about 750 cP.

In one aspect of the polyisocyanurate foam and the process for making the polyisocyanurate foam, the first reaction composition (A-side) can comprise the polyisocyanate, or alternatively, the first reaction composition (A-side) can consists essentially of the polyisocyanate. That is, the A-side can include only a sample of the polyisocyanate, and include only impurities typically present in a commercially produced or commercially available sample of the polyisocyanate.

In a further aspect, the first reaction composition (A-side) can comprises the polyisocyanate in at least about 95 wt % of the first reaction composition. In some aspect, the remainder of the A-side composition can comprise, for example, a surfactant.

Aromatic Polyester Polyol. As described above, the second reaction composition which is referred to as the B-side can comprise can comprise an aromatic polyester polyol. Specifically, the aromatic polyester polyol can have a phthalate-based (or terephthalate-based) aromatic content of at least about 30 wt % or at least about 32 wt %. In another aspect, the phthalate-based aromatic content of the aromatic polyester polyol can be up to about 44 wt %, or up to about 42 wt %, or up to about 40 wt %. Therefore, in one aspect, the aromatic polyester polyol as used herein can have an phthalate-based aromatic content of from about 30 wt % to about 44 wt %; in another aspect, the aromatic polyester polyol can have an phthalate-based aromatic content of from about 33 wt % to about 42 wt %; or alternatively, from about 35 wt % to about 40 wt %. In a further aspect, the aromatic polyester polyol used according to this disclosure can have an phthalate-based aromatic content of about 30 wt %, about 31 wt %, about 32 wt %, about 33 wt %, about 34 wt %, about 35 wt %, about 36 wt %, about 37 wt %, about 38 wt %, about 39 wt %, about 40 wt %, about 41 wt %, about 42 wt %, about 43 wt %, or about 44 wt %, or any ranges or combinations of ranges therebetween. For example, when stating that the phthalate-based aromatic content is greater than a certain value, for example, greater than about 30 wt %, the upper limit of such a recited value can be about 40 wt %.

According to an aspect, the aromatic polyester polyol can have a phenyl-based aromatic content of from about 17 wt % to about 25 wt %; from about 18 wt % to about 24 wt %; from about 19 wt % to about 23 wt %. In a further aspect, the aromatic polyester polyol used according to this disclosure can have a phenyl-based aromatic content of about 17 wt %, about 18 wt %, about 19 wt %, about 20 wt %, about 21 wt %, or about 22 wt %, about 23 wt %, or about 24 wt %, or about 25 wt %, or any ranges or collection of ranges therebetween.

According to another aspect, the polyisocyanurate foam or the process for making a polyisocyanurate foam according to this disclosure can employ an aromatic polyester polyol characterized by a Hydroxyl Number (mg KOH/g) of from about 150 to about 325. In another aspect, the aromatic polyester polyol can be characterized by a Hydroxyl Number (mg KOH/g) of from about 200 to about 315, or alternatively, from about 225 to about 300. For example, the Hydroxyl Number (mg KOH/g) of the aromatic polyester polyol can be about 150, about 160, about 170, about 180, about 190, about 200, about 210, about 220, about 230, about 240, about 250, about 260, about 270, about 280, about 290, about 300, about 310, about 320, or about 325, or any ranges or collection of ranges therebetween.

For example, in embodiments, the aromatic polyester polyol used according to this disclosure can comprise or can be selected from Isoexter® TL 250, which has a hydroxyl value of 250. According to an aspect, other aromatic polyester polyols that can be used according to this disclosure include, but are not limited to Huntsman's TEROL® 250, TEROL® 256, TEROL® 305, TEROL® 350, TEROL® 352, TEROL® 563, and Carpenter's CARPOL® PES-240, CARPOL® PES-265, CARPOL® PES-295, CARPOL® PES-305, and others, and combinations thereof. In one aspect, the aromatic polyester polyol can be derived from the use of phthalic acid or phthalic anhydride and one or more than glycols.

In an aspect of the polyisocyanurate foam and the process for making a polyisocyanurate foam, the second reaction composition (B-side) can comprise from about 45 wt % to about 65 wt % of the total amount of aromatic polyester polyol. Alternatively, the second reaction composition (B-side) can comprise: from about 47 wt % to about 63 wt %; alternatively, from about 50 wt % to about 60 wt %; or alternatively, from about 50 wt % to about 60 wt % of the aromatic polyester polyol. Each recited range includes each individual weight percentage represented by every individual integer within the recited weight percentage range, including its end points, and including any subranges therebetween. For example, reciting the range of from about 50 wt % to about 60 wt % is equivalent to reciting, individually, about 50 wt %, about 51 wt %, about 52 wt %, about 53 wt %, about 54 wt %, about 55 wt %, about 56 wt %, about 57 wt %, about 58 wt %, about 59 wt %, and about 60 wt %, including any subranges therebetween.

Blowing Agent. The second reaction composition (B-side) can also comprise a blowing agent. It has been discovered that blowing agents which perform well can comprise or can be selected from a hydrofluoroolefin (HFO), a hydrochlorofluoroolefin (HCFO), or a combination thereof. Therefore, in an aspect, the blowing agent is a non-aqueous blowing agent. In another aspect, the blowing agent is a non-saturated HFC (hydrofluorocarbon) or non-saturated HCFC (hydrochlorofluorocarbon) blowing agent. The blowing agent can also comprises a hydrofluoroolefin (HFO) blowing agent in combination with a hydrochlorofluoroolefin (HCFO).

In an aspect, the blowing agent used in fabricating the polyisocyanurate foam can comprise or can be selected from: trans-1-chloro-3,3,3-trifluoropropene (HFO-1233zd(E)); trans-1,3,3,3-tetrafluoroprop-1-ene (R-1234ze(E)); cis-1,1,1,4,4,4-hexafluoro-2-butene (HFO-1336mzz-Z); 2,3,3,3-tetrafluoropropene (HFO-1234yf); 2-chloro-3,3,3-trifluoropropene (HCFO-1233xf); or any combination thereof.

In another aspect, the blowing agent used in fabricating the polyisocyanurate foam can comprise or can be selected from trans-1-chloro-3,3,3-trifluoropropene (HFO-1233zd(E)), an example of which is Solstice® LBA (“Liquid Blowing Agent”).

In an aspect of the polyisocyanurate foam and the process for making a polyisocyanurate foam, the second reaction composition (B-side) can comprise from about 8 wt % to about 20 wt % of the total amount of blowing agent used. Alternatively, the second reaction composition (B-side) can comprise from about 10 wt % to about 18 wt %, or alternatively, from about 12 wt % to about 15 wt % of the total amount of blowing agent. Each recited range includes each individual weight percentage represented by every individual integer within the recited weight percentage range, including its end points, and including any subranges therebetween.

Catalyst. The second reaction composition (B-side) can also comprise a polyisocyanurate producing catalyst. The catalyst can be any suitable catalyst known in the art as suitable for use in the manufacture of polyurethane and polyisocyanurate foams. For example, in one aspect, the polyisocyanurate producing catalyst can comprise or can be selected from an amine compound, an organometallic catalyst, a metal carboxylate, a metal alkoxide, a metal aryloxide, a metal hydroxide, a tertiary phosphine, a quaternary ammonium salt, or a radical forming agent.

In a further aspect, the polyisocyanurate producing catalyst can comprise or can be selected from Dabco® K-15 (potassium octoate solution), Dabco® BL-19, Polycat® 46 (potassium acetate solution), Fomrez® UL22 (dimethyltin mercaptide catalyst), bis(2-dimethylaminoethyl)ether, or any combination thereof.

For example, suitable catalyst can also include or can be selected from metal carboxylates, such as metal acetates, metal hexoates (or “hexanoate”), or metal octoates (or “octanoates”), such as sodium or potassium metal salts thereof. In an aspect, suitable catalysts can include or can be selected from potassium acetate, potassium octoate, and similar alkali metal or alkali metal salt compounds. Other suitable catalysts can include or can be selected from alkali metal alcoholates, alkali metal phenolates, alkaki metal hydroxides, or any conbination thereof.

In a further aspect, organotin compounds can be used as catalysts. Suitable organotin compounds include, but are not limited to, dibutyltin dilaurate, dibutyltin bis(2-ethylhexanoate) and combinations thereof. Other tin compounds such as organic acid salts of tin can be uased as catalysts, such as stannous oleate, tin 2-ethylcaproate, tin naphthoate, tin octylate, or combinations thereof.

In an aspect of the polyisocyanurate foam and the process for making a polyisocyanurate foam, the second reaction composition (B-side) can comprise from about 1 wt % to about 10 wt % of the total amount of catalyst. Alternatively, the second reaction composition (B-side) can comprise from about 2 wt % to about 8 wt %, or alternatively, from about 3 wt % to about 7 wt % of the total amount of catalyst. Each recited range includes each individual weight percentage represented by every individual integer within the recited weight percentage range, including its end points, and including any subranges therebetween.

Flame Retardant. The second reaction composition (B-side) can also comprise a flame retardant, and any flame retardant suitable for use in polyisocyanurate foams can be used. In one aspect, for example, the flame-retardant can comprise or can be selected from a phosphate compound.

In an aspect, the flame retardant can comprise or can be selected from tris-(2-chloro-1-methylethyl)phosphate (TMCP), low-odor tris-(2-chloro-1-methylethyl)phosphate (TCPP-LO), tris-(chloroethyl)phosphate (TCEP), tris(chloroisopropyl)phosphate (TCPP), tri-cresyl phosphate (TCP), tris-(1,3-dichloro-2-propyl)phosphate (TDCP), low-viscosity tris-(1,3-dichloro-2-propyl)phosphate (TDCP-LV), or any combinations thereof. In one aspect, the flame retardant can comprise or can be selected from the chlorinated phosphate resin TCPP, tris(chloroisopropyl)pho sphate.

In another aspect, the flame retardant can comprise or can be selected from other halogenated compounds, including chlorinated compounds and/or a brominated compounds. For example, the flame retardant can comprise or can be selected from TBPA Diol, which tetrabromophthalic anhydride polyester diol, although a range of brominated flame retardants can be used.

In a further aspect, the flame retardant can comprise or can be selected from any combination of at least one chlorinated phosphate resins halogenated compounds such as those disclosed above, and any of the other halogenated compounds such as the other chlorinated and other brominated compounds disclosed above. For example, in this aspect, the flame retardant can comprise or can be selected from a combination of tris(chloroisopropyl)phosphate (TCPP) and TBPA Diol, but is not limited to this combination.

According to yet another aspect, a non-halogenated flame retardant component can be used in place of a halogenated flame retardant compound. Examples of non-halogenated flame retardants which may be used can comprise or can be selected from organophosphorous compounds including but not limited to organophosphate compounds, organophosphite compounds, organophosphonate compounds, or any combination thereof. Suitable organo-phosphate compounds can comprise or can be selected from alkyl and/or aryl phosphate compounds such as butyl diphenyl phosphate, dibutyl phenyl phosphate, triethyl phosphate, and triphenyl phosphate, among others, or combinations thereof. Exemplary organophosphite compounds can comprise or can be selected from alkyl and/or aryl phosphite compounds such as butyl diphenyl phosphite, dibutyl phenyl phosphite, triethyl phosphite, and triphenyl phosphite, among others, or combinations thereof. Suitable organophosphonate compounds can comprise or can be selected from alkyl, aryl, and/or hydroxyalkyl phosphonates such as diethylhydroxy-methylphosphonate (DEHMP). In a further aspect, a combination of at least one halogenated flame retardant and at least one non-halogenated flame retardant can be used.

In an aspect, some flame retardant materials such as TBPA Diol can provide additional polyester polyol functionality and additional aromatic content to the total “aromatic polyester polyol” used in the B-side composition, beyond that provided by the non-halogenated aromatic polyester polyol in the B-side. In one aspect, and unless otherwise specified, the aromatic content numbers recited for the aromatic polyester polyol component of the B-side can be for the non-halogenated, the non-brominated, and/or the non-chlorinated aromatic polyester polyol and do not include any additional aromatic functionality provided by a flame retardant component of this type. In a further aspect, when a flame retardant material such as TBPA Diol is used which can provide additional polyester polyol functionality and additional aromatic content to the total “aromatic polyester polyol” used in the B-side composition, the “total aromatic content” in the combined halogenated and non-halogenated aromatic polyester polyol can be, for example, about +1% greater, +2% greater, +3% greater, +5% greater, or even more, than phenyl-based or phthalate-based (terephthalate-based) content of the non-halogenated aromatic polyester polyol.

The flame retardant can be used in an amount is sufficient to meet or exceed the test standards set forth in DIN 4102 B2 flammability test, or the ASTM E-84 flame and smoke tests.

In an aspect of the polyisocyanurate foam and the process for making a polyisocyanurate foam, the second reaction composition (B-side) can comprise from about 10 wt % to about 30 wt % of the total amount of flame retardant. Alternatively, the second reaction composition (B-side) can comprise from about 12 wt % to about 28 wt %, or alternatively, from about 15 wt % to about 25 wt % of the total amount of flame retardant. Each recited range includes each individual weight percentage represented by every individual integer within the recited weight percentage range, including its end points, and including any subranges therebetween.

Surfactant. The second reaction composition (B-side) can also comprise a surfactant. In an aspect, for example the surfactant can comprise or can be selected from a non-ionic surfactant. In another aspect, the surfactant can comprise or can be selected from a silicone surfactant. For example, in an aspect, the surfactant can comprise Surfonic® N95 (non-ionic surfactant), Vorasurf® DC 193 (silicone surfactant), or any combination thereof.

In an aspect of the polyisocyanurate foam and the process for making a polyisocyanurate foam, the second reaction composition (B-side) can comprise from about 1 wt % to about 10 wt % of the total amount of surfactant. Alternatively, the second reaction composition (B-side) can comprise from about 2 wt % to about 8 wt %, or alternatively, from about 3 wt % to about 7 wt % of the total amount of surfactant. Each recited range includes each individual weight percentage represented by every individual integer within the recited weight percentage range, including its end points, and including any subranges therebetween.

Water. The second reaction composition (B-side) can also comprise water. In an aspect of the polyisocyanurate foam and the process for making a polyisocyanurate foam, the second reaction composition (B-side) can comprise from about 0 wt % to about 10 wt % water. Alternatively, the second reaction composition (B-side) can comprise from about 0.1 wt % to about 8 wt %, or alternatively, from about 0.5 wt % to about 5 wt % of the amount of water. Each recited range includes each individual weight percentage represented by every individual integer within the recited weight percentage range, including its end points, and including any subranges therebetween.

Other Components. The second reaction composition (B-side) can also comprise a number of other components that may be considered optional components, in that embodiments are known in which any or all of these other components are absent, and embodiments are known in which any or all of these other components are present. Various optional components are well understood by the person of ordinary skill in the art.

In an aspect for example, optional components include but are not limited to, a plasticizer, an emulsifier, a biocide, a bacteriostat, a filler, a dye or colorant, an anti-scorching agent, a chain extender or cross-linker, an antioxidant, an antistatic agent, a cell-opening agent, or any combination thereof.

In an aspect, for example, the second reaction composition (B-side) used to make the polyisocyanurate form can comprise a plasticizer. In another aspect, the plasticizer can be selected from a phthalate plasticizer, a phosphate or phosphorus-containing plasticizer, or a benzoate plasticizer. In some aspects, the flame retardant compounds can comprise or can be selected from a phosphate compound, and the phosphate compound can exhibit plasticizing properties.

Process Parameters. In one aspect of the disclosure, the first reaction composition (A-side) and the second reaction composition (B-side) are used in “off-ratio” A-side:B-side volume ratios (v:v), which uses a higher volume of A-side than the volume of B-side and therefore which departs from the roughly 1:1 (v:v) ratio common in spray polyurethane foams. Therefore, according to an aspect, the first reaction composition (A-side) and the second reaction composition (B-side) are used in amounts to provide an A-side:B-side volume ratio (v:v) of from 1.2:1 to 2.2:1. In other aspects, the first reaction composition (A-side) and the second reaction composition (B-side) are used in amounts to provide an A-side:B-side volume ratio (v:v) of from 1.27:1 to 2.1:1; or alternatively, an A-side:B-side volume ratio (v:v) of from 1.35:1 to 2.0:1. For example, the A-side:B-side volume ratio (v:v) can be about 1.2, about 1.3, about 1.4, about 1.5, about 1.6, about 1.7, about 1.8, about 1.9, about 2.0, or about 2.1, or any ranges or combination of ranges therebetween.

According to a further aspect, the process can be carried out using amounts of the A-side components and the B-side components to provide an Isocyanate Index (ISO Index) that is from about 150 to about 375 (expressed as a percentage). According to another aspect, the Isocyanate Index (ISO Index) can be from about 175 to about 350; alternatively, from about 200 to about 350; alternatively, from about 190 to about 325; alternatively, from about 200 to about 300; alternatively, from about 210 to 275; or alternatively, from about 215 to 255. In an aspect, the Isocyanate Index (ISO Index) can be about 150, about 160, about 170, about 180, about 190, about 200, about 210, about 220, about 230, about 240, about 250, about 260, about 270, about 280, about 290, about 300, about 310, about 320, about 330, about 340, about 350, about 360, about 370, or about 375, or any ranges or combination of ranges therebetween.

Foam Properties. In addition to the properties of the resulting foam disclosed herein, the flame-retardant polyisocyanurate (PIR) foam prepared as described herein can have density from about 1.4 lb/ft³ to about 2.6 lb/ft³; alternatively, from about 1.5 lb/ft³ to about 2.5 lb/ft³; alternatively, from about 1.6 lb/ft³ to about 2.3 lb/ft³; or alternatively, from about 1.7 lb/ft³ to about 2.1 lb/ft³. Therefore, in an aspect, the PIR foam density can be about 1.4 lb/ft³, about 1.5 lb/ft³, about 1.6 lb/ft³, about 1.7 lb/ft³, about 1.8 lb/ft³, about 1.9 lb/ft³, about 2.0 lb/ft³, about 2.1 lb/ft³, about 2.2 lb/ft³, about 2.3 lb/ft³, about 2.4 lb/ft³, about 2.5 lb/ft³, or about 2.6 lb/ft³, or , or any ranges or combination of ranges therebetween.

As disclosed herein, the resulting PIR foam can exhibit improved fire and flame retardant and thermal barrier properties. For example, a polyurethane foam that is capable of passing certain thermal barrier tests in the presence or in the absence of a protective covering such as a code-prescribed thermal barrier. In an aspect, for example, the polyisocyanurate (PIR) foams of this disclosure can pass one or more thermal barrier tests such as NFPA 286 or UL 1715. In another aspect, the PIR foam passes one or more thermal barrier tests such as NFPA 286 or UL 1715 in the absence of a protective coating.

### EXAMPLES

The following examples are not intended to be limiting, but rather representative of the various embodiments and aspects of the disclosure. The foams produced in these examples are generated using different volumetric ratios of the first reaction composition (A-side) to the second reaction composition (B-side), therefore providing different NCO indices, as shown.

In addition to the ranges of weight percentages of components set out above, for each of the Examples provided herein, variations are possible for each reported mass of each component in Tables 1-3. For example, in Table 1-3, the mass of the Isoexter® TL 250 in the B-side component (resin) is given as 55.00, which is relative to the other components in the B-side. In an aspect, the relative mass of each component in the Tables can vary, independently, by about ±1% of the reported relative mass, about ±3% of the reported relative mass, about ±5% of the reported relative mass, about ±10% of the reported relative mass, about ±15% of the reported relative mass, or about ±20% of the reported relative mass. As an example, because the Isoexter® TL 250 mass in the B-side component in each Example is 55.00, this relative mass can vary independently of the other components, ±10% of the reported relative mass. Therefore the Isoexter® TL 250 relative mass can be from 49.5 to 60.5 (55.5±5.5). This variation in the relative mass of Isoexter® TL 250 is independent of the variation in the relative mass of the other components recited in these examples and tables.

### Example 1

The following table provides the listing of the components of the first reaction composition (A-side) comprising a polyisocyanate and the second reaction composition (B-side) comprising the aromatic polyester polyol for Example 1. In this example, the PIR foam is produced using an A-side:B-side volumetric ratio of 1.36:1, which provides an NCO Index of 2.27 reported as a fraction (227 reported as a percent). The aromatic content of the Isoexter® TL 250 used in this and subsequent Examples is 21 wt % (phenyl-based) or 38 wt % (terephthalate based).

### Example 2

The following table provides the listing of the components of the first reaction composition (A-side) comprising a polyisocyanate and the second reaction composition (B-side) comprising the aromatic polyester polyol for Example 2. In this example, the PIR foam is produced using an A-side:B-side volumetric ratio of 1.50:1, which provides an NCO Index of 2.50 (fractional; 250 reported as a percent).

### Example 3

The following table provides the listing of the components of the first reaction composition (A-side) comprising a polyisocyanate and the second reaction composition (B-side) comprising the aromatic polyester polyol for Example 3. In this example, the PIR foam is produced using an A-side:B-side volumetric ratio of 2.00:1, which provides an NCO Index of 3.34 (fractional; 334 reported as a percent).

### ASPECTS OF THE DISCLOSURE

As described herein, these and other embodiments, aspects, features, and descriptions of the present invention can be further disclosed according to the various numbered Aspects of the Disclosure as set out below.

Aspect 1. A flame-retardant polyisocyanurate (PIR) foam, the foam comprising the contact product of:

(a) a first reaction composition (A-side) comprising a polyisocyanate component having a viscosity (25° C., mPa·S) of from about 600 cP to about 850 cP and having [1] an isocyanate functionality of from about 2.5 to about 3.5, or [2] an NCO content (wt %) of from about 25 wt % to about 35 wt %; and

(b) a second reaction composition (B-side) comprising:
an aromatic polyester polyol comprising a phthalate-based aromatic content of at least about 30 wt %;
a blowing agent comprising a hydrofluoroolefin (HFO), a hydrochlorofluoroolefin (HCFO), or a combination thereof;
a polyisocyanurate producing catalyst;
a flame retardant; and
a surfactant;

wherein the first reaction composition (A-side) and the second reaction composition (B-side) are used in amounts to provide an A-side:B-side volume ratio (v:v) of from 1.2:1 to 2.2:1; and

wherein the first reaction composition and the second reaction composition are used in amounts to provide an Isocyanate Index of 150 to 375 (expressed as a percentage).

Aspect 2. A process for making a flame-retardant polyisocyanurate (PIR) foam, the process comprising contacting:

(a) a first reaction composition (A-side) comprising a polyisocyanate component having a viscosity (25° C., mPa·S) of from about 600 cP to about 850 cP and having [1] an isocyanate functionality of from about 2.5 to about 3.5, or [2] an NCO content (wt %) of from about 25 wt % to about 35 wt %; and

(b) a second reaction composition (B-side) comprising:
an aromatic polyester polyol comprising a phthalate-based aromatic content of at least about 30 wt %;
a blowing agent comprising a hydrofluoroolefin (HFO), a hydrochlorofluoroolefin (HCFO), or a combination thereof;
a polyisocyanurate producing catalyst;
a flame-retardant; and
a surfactant;

wherein the first reaction composition (A-side) and the second reaction composition (B-side) are used in amounts to provide an A-side:B-side volume ratio (v:v) of from 1.2:1 to 2.2:1; and

wherein the first reaction composition and the second reaction composition are used in amounts to provide an Isocyanate Index of 150 to 375.

Aspect 3. A polyisocyanurate foam or a process for making a polyisocyanurate foam according to any of the previous Aspects, wherein the polyisocyanate component has an isocyanate functionality of from about 2.8 to about 3.3 (e.g. WANNATE® PM-700).

Aspect 4. A polyisocyanurate foam or a process for making a polyisocyanurate foam according to any of the previous Aspects, wherein the polyisocyanate component comprises from about 30 wt % to about 70 wt % of methylene diphenyl diisocyanate (MDI) and from about 70 wt % to about 30 wt % of polymeric methylene diphenyl diisocyanate (polymeric MDI) (e.g. WANNATE® PM-700).

Aspect 5. A polyisocyanurate foam or a process for making a polyisocyanurate foam according to any of the previous Aspects, wherein the polyisocyanate component has an isocyanate functionality of from about 3.0 to about 3.1, an NCO content (wt %) of from about 29 wt % to about 33 wt %, and a viscosity (25° C., mPa·S) of from about 650 cP to about 750 cP.

Aspect 6. A polyisocyanurate foam or a process for making a polyisocyanurate foam according to any of the previous Aspects, wherein the aromatic polyester polyol is characterized by a Hydroxyl Number (mg KOH/g) of from about 150 to about 325.

Aspect 7. A polyisocyanurate foam or a process for making a polyisocyanurate foam according to any of the previous Aspects, wherein the aromatic polyester polyol is characterized by a Hydroxyl Number (mg KOH/g) of from about 200 to about 315.

Aspect 8. A polyisocyanurate foam or a process for making a polyisocyanurate foam according to any of the previous Aspects, wherein the aromatic polyester polyol comprises a phthalate-based aromatic content of from about 30 wt % to about 44 wt %, or from about 30 wt % to about 42 wt %.

Aspect 9. A polyisocyanurate foam or a process for making a polyisocyanurate foam according to any of the previous Aspects, wherein the aromatic polyester polyol comprises a phthalate-based aromatic content of from about 33 wt % to about 40 wt %.

Aspect 10. A polyisocyanurate foam or a process for making a polyisocyanurate foam according to any of the previous Aspects, wherein the aromatic polyester polyol comprises a phenyl-based aromatic content of from about 17 wt % to about 25 wt %; or alternatively, from about 18 wt % to about 24 wt %.

Aspect 11. A polyisocyanurate foam or a process for making a polyisocyanurate foam according to any of the previous Aspects, wherein the aromatic polyester polyol comprises Isoexter® TL 250, TEROL® 250, TEROL® 256, TEROL® 305, TEROL® 350, TEROL® 352, TEROL® 563, CARPOL® PES-240, CARPOL® PES-265, CARPOL® PES-295, CARPOL® PES-305, or any combination thereof.

Aspect 12. A polyisocyanurate foam or a process for making a polyisocyanurate foam according to any of the previous Aspects, wherein the blowing agent comprises:

trans-1-chloro-3,3,3-trifluoropropene (HFO-1233zd(E));

trans-1,3,3,3-tetrafluoroprop-1-ene (R-1234ze(E));

cis-1,1,1,4,4,4-hexafluoro-2-butene (HFO-1336mzz-Z);

2,3,3,3-tetrafluoropropene (HFO-1234yf);

2-chloro-3,3,3-trifluoropropene (HCFO-1233xf); or

any combination thereof.

Aspect 13. A polyisocyanurate foam or a process for making a polyisocyanurate foam according to any of the previous Aspects, wherein the blowing agent comprises a hydrofluoroolefin (HFO) blowing agent in combination with a hydrochlorofluoroolefin (HCFO).

Aspect 14. A polyisocyanurate foam or a process for making a polyisocyanurate foam according to any of the previous Aspects, wherein the polyisocyanurate producing catalyst comprises an amine compound, an organometallic catalyst, a metal carboxylate, a metal alkoxide, a metal aryloxide, a metal hydroxide, a tertiary phosphine, a quaternary ammonium salt, or a radical forming agent.

Aspect 15. A polyisocyanurate foam or a process for making a polyisocyanurate foam according to any of the previous Aspects, wherein the polyisocyanurate producing catalyst comprises Dabco® K-15 (potassium octoate solution), Dabco® BL-19, Polycat® 46 (potassium acetate solution), Fomrez® UL22 (dimethyltin mercaptide catalyst), bis(2-dimethylamino-ethyl)ether, or any combination thereof.

Aspect 16. A polyisocyanurate foam or a process for making a polyisocyanurate foam according to any of the previous Aspects, wherein the flame-retardant comprises a phosphate compound.

Aspect 17. A polyisocyanurate foam or a process for making a polyisocyanurate foam according to any of the previous Aspects, wherein the flame retardant is selected from tris-(2-chloro-1-methylethyl)phosphate (TMCP), low-odor tris-(2-chloro-1-methylethyl)phosphate (TCPP-LO), tris-(chloroethyl)phosphate (TCEP), tris(chloroisopropyl)phosphate (TCPP), tri-cresyl phosphate (TCP), tris-(1,3-dichloro-2-propyl)phosphate (TDCP), low-viscosity tris-(1,3-dichloro-2-propyl)phosphate (TDCP-LV), TBPA Diol, or combinations thereof.

Aspect 18. A polyisocyanurate foam or a process for making a polyisocyanurate foam according to any of the previous Aspects, wherein the surfactant comprises a non-ionic surfactant, a silicone surfactant, or a combination thereof.

Aspect 19. A polyisocyanurate foam or a process for making a polyisocyanurate foam according to any of the previous Aspects, wherein the surfactant comprises Surfonic® N95 (non-ionic surfactant), Vorasurf® DC 193 (silicone surfactant), or a combination thereof.

Aspect 20. A polyisocyanurate foam or a process for making a polyisocyanurate foam according to any of the previous Aspects, wherein the first reaction composition (A-side) consists essentially of the polyisocyanate.

Aspect 21. A polyisocyanurate foam or a process for making a polyisocyanurate foam according to any of the previous Aspects, wherein the first reaction composition (A-side) comprises the polyisocyanate in at least about 95 wt % of the first reaction composition.

Aspect 22. A polyisocyanurate foam or a process for making a polyisocyanurate foam according to any of the previous Aspects, wherein the second reaction composition comprises from about 45 wt % to about 65 wt % or from about 50 wt % to about 60 wt % of the aromatic polyester polyol.

Aspect 23. A polyisocyanurate foam or a process for making a polyisocyanurate foam according to any of the previous Aspects, wherein the second reaction composition comprises from about 1 wt % to about 10 wt % or from about 3 wt % to about 7 wt % of the surfactant.

Aspect 24. A polyisocyanurate foam or a process for making a polyisocyanurate foam according to any of the previous Aspects, wherein the second reaction composition comprises from about 8 wt % to about 20 wt % or from about 12 wt % to about 15 wt % of the blowing agent.

Aspect 25. A polyisocyanurate foam or a process for making a polyisocyanurate foam according to any of the previous Aspects, wherein the second reaction composition comprises from about 1 wt % to about 10 wt % or from about 3 wt % to about 7 wt % of the polyisocyanurate producing catalyst.

Aspect 26. A polyisocyanurate foam or a process for making a polyisocyanurate foam according to any of the previous Aspects, wherein the second reaction composition comprises from about 10 wt % to about 30 wt % or from about 15 wt % to about 25 wt % of the flame-retardant.

Aspect 27. A polyisocyanurate foam or a process for making a polyisocyanurate foam according to any of the previous Aspects, wherein the flame-retardant PIR foam has a density from about 1.5 lb/ft³ to about 2.5 lb/ft³.

Aspect 28. A polyisocyanurate foam or a process for making a polyisocyanurate foam according to any of the previous Aspects, wherein the first reaction composition (A-side) and the second reaction composition (B-side) are used in amounts to provide an A-side:B-side volume ratio (v:v) of from 1.27:1 to 2.1:1.

Aspect 29. A polyisocyanurate foam or a process for making a polyisocyanurate foam according to any of the previous Aspects, wherein the first reaction composition (A-side) and the second reaction composition (B-side) are used in amounts to provide an A-side:B-side volume ratio (v:v) of from 1.35:1 to 2.0:1.

Aspect 30. A polyisocyanurate foam or a process for making a polyisocyanurate foam according to any of the previous Aspects, wherein the first reaction composition and the second reaction composition are used in amounts to provide an Isocyanate Index (as a percentage) of 200 to 350.

Aspect 31. A polyisocyanurate foam or a process for making a polyisocyanurate foam according to any of the previous Aspects, wherein the first reaction composition and the second reaction composition are used in amounts to provide an Isocyanate Index (as a percentage) of 200 to 300.

Aspect 32. A polyisocyanurate foam or a process for making a polyisocyanurate foam according to any of the previous Aspects, wherein the second reaction composition further comprises a plasticizer selected from a phthalate plasticizer, a phosphate or phosphorus-containing plasticizer, or a benzoate plasticizer.

Aspect 33. A polyisocyanurate foam or a process for making a polyisocyanurate foam according to any of the previous Aspects, wherein the second reaction composition further comprises any one or more of a plasticizer, an emulsifier, a biocide, a bacteriostat, a filler, a dye or colorant, an anti-scorching agent, a cross-linker, an antioxidant, an antistatic agent, or a cell-opening agent.

Aspect 34. A polyisocyanurate foam or a process for making a polyisocyanurate foam according to any of the previous Aspects, wherein the first reaction composition (A-side) further comprises a surfactant.

Aspect 35. A polyisocyanurate foam or a process for making a polyisocyanurate foam according to any of the previous Aspects, wherein the PIR foam passes one or more thermal barrier tests selected from NFPA 286, UL 1715, or a combination thereof.

Aspect 36. A polyisocyanurate foam or a process for making a polyisocyanurate foam according to any of the previous Aspects, wherein the PIR foam passes one or more thermal barrier tests selected from NFPA 286, UL 1715, or a combination thereof, in the absence of a protective coating.

Aspect 37. A polyisocyanurate foam or a process for making a polyisocyanurate foam according to the formulation of Table 1.

Aspect 38. A polyisocyanurate foam or a process for making a polyisocyanurate foam according to the formulation of Table 2.

Aspect 39. A polyisocyanurate foam or a process for making a polyisocyanurate foam according to the formulation of Table 3.

What is claimed is:

1. A flame-retardant polyisocyanurate (PIR) foam, the foam comprising the contact product of:
(a) a first reaction composition (A-side) comprising a polyisocyanate component having a viscosity (25° C., mPa·S) of from about 600 cP to about 850 cP and having [1] an isocyanate functionality of from about 2.5 to about 3.5, or [2] an NCO content (wt %) of from about 25 wt % to about 35 wt %; and
(b) a second reaction composition (B-side) comprising:
an aromatic polyester polyol comprising a phthalate-based aromatic content of at least about 30 wt %;
a blowing agent comprising a hydrofluoroolefin (HFO), a hydrochlorofluoroolefin (HCFO), or a combination thereof;
a polyisocyanurate producing catalyst;
a flame retardant; and
a surfactant;
wherein the first reaction composition (A-side) and the second reaction composition (B-side) are used in amounts to provide an A-side:B-side volume ratio (v:v) of from 1.2:1 to 2.2:1; and
wherein the first reaction composition and the second reaction composition are used in amounts to provide an Isocyanate Index of 150 to 375 (expressed as a percentage).

2. A polyisocyanurate foam according to claim 1, wherein the polyisocyanate component has an isocyanate functionality of from about 2.8 to about 3.3.

3. A polyisocyanurate foam according to claim 1, wherein the polyisocyanate component has an isocyanate functionality of from about 3.0 to about 3.1, an NCO content (wt %) of from about 29 wt % to about 33 wt %, and a viscosity (25° C., mPa·S) of from about 650 cP to about 750 cP.

4. A polyisocyanurate foam according to claim 1, wherein the aromatic polyester polyol is characterized by a Hydroxyl Number (mg KOH/g) of from about 150 to about 325.

5. A polyisocyanurate foam according to claim 1, wherein the aromatic polyester polyol comprises a phthalate-based aromatic content of from about 30 wt % to about 44 wt % or a phenyl-based aromatic content of from about 17 wt % to about 25 wt %.

6. A polyisocyanurate foam according to claim 1, wherein the aromatic polyester polyol comprises Isoexter® TL 250, TEROL® 250, TEROL® 256, TEROL® 305, TEROL® 350, TEROL® 352, TEROL® 563, CARPOL® PES-240, CARPOL® PES-265, CARPOL® PES-295, CARPOL® PES-305, or any combination thereof.

7. A polyisocyanurate foam according to claim 1, wherein the blowing agent comprises:
trans-1-chloro-3,3,3-trifluoropropene (HFO-1233zd(E));
trans-1,3,3,3-tetrafluoroprop-1-ene (R-1234ze(E));
cis-1,1,1,4,4,4-hexafluoro-2-butene (HFO-1336mzz-Z);
2,3,3,3-tetrafluoropropene (HFO-1234yf);
2-chloro-3,3,3-trifluoropropene (HCFO-1233xf); or
any combination thereof.

8. A polyisocyanurate foam according to claim 1, wherein the blowing agent comprises a hydrofluoroolefin (HFO) blowing agent in combination with a hydrochlorofluoroolefin (HCFO).

9. A polyisocyanurate foam according to claim 1, wherein the polyisocyanurate producing catalyst comprises an amine compound, an organometallic catalyst, a metal carboxylate, a metal alkoxide, a metal aryloxide, a metal hydroxide, a tertiary phosphine, a quaternary ammonium salt, or a radical forming agent.

10. A polyisocyanurate foam according to claim 1, wherein the flame-retardant comprises a phosphate compound.

11. A polyisocyanurate foam according to claim 1, wherein the flame retardant is selected from tris-(2-chloro-1-methylethyl)phosphate (TMCP), low-odor tris-(2-chloro-1-methylethyl)-phosphate (TCPP-LO), tris-(chloroethyl)phosphate (TCEP), tris(chloroisopropyl)phosphate (TCPP), tri-cresyl phosphate (TCP), tris-(1,3-dichloro-2-propyl)phosphate (TDCP), low-viscosity tris-(1,3-dichloro-2-propyl)phosphate (TDCP-LV), TBPA Diol, or combinations thereof.

12. A polyisocyanurate foam according to claim 1, wherein the surfactant comprises a non-ionic surfactant, a silicone surfactant, or a combination thereof.

13. A polyisocyanurate foam according to claim 1, wherein the first reaction composition (A-side) consists essentially of the polyisocyanate.

14. A polyisocyanurate foam according to claim 1, wherein:
the first reaction composition (A-side) comprises the polyisocyanate in a concentration of greater than or equal to 95 wt % of the first reaction composition;
the second reaction composition comprises from about 45 wt % to about 65 wt % of the aromatic polyester polyol, from about 1 wt % to about 10 wt % of the surfactant, from about 8 wt % to about 20 wt % of the blowing agent, from about 1 wt % to about 10 wt % of the polyisocyanurate producing catalyst, and from about 10 wt % to about 30 wt % of the flame-retardant.

15. A polyisocyanurate foam according to claim 1, wherein the flame-retardant PIR foam has a density from about 1.5 lb/ft³ to about 2.5 lb/ft³.

16. A polyisocyanurate foam according to claim 1, wherein the first reaction composition and the second reaction composition are used in amounts to provide an Isocyanate Index (as a percentage) of 200 to 350.

17. A polyisocyanurate foam according to claim 1, wherein the second reaction composition further comprises any one or more of a plasticizer, an emulsifier, a biocide, a bacteriostat, a filler, a dye or colorant, an anti-scorching agent, a cross-linker, an antioxidant, an antistatic agent, or a cell-opening agent.

18. A polyisocyanurate foam according to claim 1, wherein the PIR foam passes one or more thermal barrier tests selected from NFPA 286, UL 1715, or a combination thereof, in the presence or in the absence of a protective coating.

19. A process for making a flame-retardant polyisocyanurate (PIR) foam, the process comprising contacting:
(a) a first reaction composition (A-side) comprising a polyisocyanate component having a viscosity (25° C., mPa·S) of from about 600 cP to about 850 cP and having [1] an isocyanate functionality of from about 2.5 to about 3.5, or [2] an NCO content (wt %) of from about 25 wt % to about 35 wt %; and
(b) a second reaction composition (B-side) comprising:
an aromatic polyester polyol comprising a phthalate-based aromatic content of at least about 30 wt %;
a blowing agent comprising a hydrofluoroolefin (HFO), a hydrochlorofluoroolefin (HCFO), or a combination thereof;
a polyisocyanurate producing catalyst;
a flame-retardant; and
a surfactant;
wherein the first reaction composition (A-side) and the second reaction composition (B-side) are used in amounts to provide an A-side:B-side volume ratio (v:v) of from 1.2:1 to 2.2:1; and
wherein the first reaction composition and the second reaction composition are used in amounts to provide an Isocyanate Index of 150 to 375.

20. A process for making a polyisocyanurate foam according to claim 19, wherein:
the polyisocyanate component has an isocyanate functionality of from about 3.0 to about 3.1, an NCO content (wt %) of from about 29 wt % to about 33 wt %, and a viscosity (25° C., mPa·S) of from about 650 cP to about 750 cP; and
the aromatic polyester polyol is characterized by a Hydroxyl Number (mg KOH/g) of from about 150 to about 325.
